(19) United States
(12) Patent Application Publication
(10) Pub. No.: US 2012/0159557 A1
(43) Pub. Date: Jun. 21, 2012

(54) APPARATUS AND METHOD FOR CONTROLLING CONTENTS TRANSMISSION

(75) Inventors: Kwihoon KIM, Daejeon (KR); Chung Hyun AHN, Daejeon (KR); Jin Woo HONG, Daejeon (KR)

(73) Assignee: Electronics and Telecommunications Research Institute, Daejeon (KR)

(21) Appl. No.: 13/328,845

(22) Filed: Dec. 16, 2011

(30) Foreign Application Priority Data
Dec. 16, 2010 (KR) 10-2010-0129402
Jun. 24, 2011 (KR) 10-2011-0061884

(51) Int. Cl. H04N 7/18

(52) U.S. Cl. 725/81

(57) ABSTRACT

An apparatus for controlling contents transmission transmits contents received at a TV to at least one user terminal requesting a service. The apparatus selects at least one connection of a target terminal using user profile information of the target terminal and service profile information, coding the contents based on a coding scheme suitable for the selected connection, and transmits the coded contents to the target terminal.

### CROSS-REFERENCE TO RELATED APPLICATION

This application claims priority to and the benefit of Korean Patent Application No. 10-2010-0129402 and 10-2011-0061884 filed in the Korean Intellectual Property Office on Dec. 16, 2010 and Jun. 24, 2011, the entire contents of which are incorporated herein by reference.

### BACKGROUND OF THE INVENTION

(a) Field of the Invention

The present invention relates to an apparatus and method for controlling contents transmission, and particularly, to an apparatus and method for controlling contents transmission to provide contents provided through a smart TV in a house to at least one user terminal through place-shift.

(b) Description of the Related Art

Various access technologies such as cellular, WiFi, Bluetooth, and wideband wireless access have been introduced. The access technologies will be diversifying as the Internet and a network are developed. Accordingly, a user terminal such as a PDA or a smart phone employs a plurality of network interfaces to support various networks.

As a smart TV has been popular, a video call can be provided through the smart TV. A multi-screen can be also provided by connecting a smart phone to a smart TV. In order to provide such services, it is, however, required to use a smart phone that can be connected to the smart TV. There is also a limitation of a channel because such service can be provided for only one channel. Furthermore, mobility is not provided because the smart phone is connected to the smart TV through a wired link.

### SUMMARY OF THE INVENTION

The present invention has been made in an effort to provide an apparatus and method for controlling contents transmission having advantages of providing different contents to at least one terminal based on a TV.

The present invention has been made in an effort to provide an apparatus and method for controlling contents transmission having advantages of providing contents mobility to a terminal of a moving user based on a TV.

An exemplary embodiment of the present invention provides a method for controlling transmission of contents received at a TV, which is performed by an apparatus for controlling transmission of contents. The method includes receiving a service request from at least one user terminal, establishing a connection to the at least one user terminal, confirming user profile information of each user terminal and service characteristic information of services requested by each user terminal, and transmitting contents of a corresponding service through at least one connection of each user terminal using the user profile information of each user terminal and the service characteristic information.

the transmitting contents may include selecting the at least one connection of each user terminal using the user profile information of each user terminal.

The transmitting contents may further include deciding a coding scheme suitable to the at least one connection, and coding the contents based on the coding scheme.

The transmitting contents may further include separating and transmitting the contents of a corresponding service through at least one connection of each user terminal according to service characteristic information of each user terminal.

The service profile information may include QoS information, and the transmitting contents may include requesting guarantee of QoS of contents according to the QoS information.

The method may further include detecting change of an access network of each user terminal due to movement of each user terminal, and establishing a connection to the changed access network of each user terminal. Another exemplary embodiment of the present invention provides a method for controlling transmission of contents received at a TV, which is performed in an apparatus for controlling contents transmission. The method may include receiving a service request from a user through a first user terminal, transmitting contents of a requested service through at least one connection of the first user terminal using user profile information of the first user terminal and service characteristic information of the requested service, detecting movement of the user, and transmitting contents of the requested service through at least one connection of a second user terminal using user profile information of the second user terminal at a location where the user moves to.

The transmitting contents of the requested service through at least one connection of a second user terminal may include transmitting contents of the requested service through at least one connection of the first user terminal.

The transmitting contents of the requested service through at least one connection of a second user terminal may further include Interrupting transmission of the contents to the first user terminal.

Still another exemplary embodiment of the present invention provides an apparatus for controlling transmission of contents received at a TV. The apparatus may include a multi-user control server and a multi-connection control server. The multi-user control server may independently control a channel by a user terminal that requests a service. The multi-connection control server may confirm connection information and a connection state of each terminal requesting the service, select at least one connection of each user terminal to transmit contents corresponding to the service based on the connection information and the connection state, and transmit the contents through the at least one connection of each user terminal.

The apparatus may further include a multi-channel transcoder for coding the contents based on a coding scheme suitable to the at least one connection of each user terminal.

The multi-connection control server may decide the coding scheme suitable to the at least one connection of each user terminal.

### BRIEF DESCRIPTION OF THE DRAWINGS

FIG. 1 illustrates network configuration where an apparatus for controlling transmission of contents in accordance with an exemplary embodiment of the present invention is applied to.

FIG. 2 illustrates a method for controlling transmission of contents, which is performed by an apparatus for controlling transmission of contents in accordance with an exemplary embodiment of the present invention.

FIG. 3 illustrates an apparatus for controlling transmission of contents of FIG. 1.

FIG. 4 to FIG. 6 illustrate a method for controlling transmission of contents in accordance with the first to third exemplary embodiments of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements.

Hereinafter, an apparatus and method for controlling contents transmission in accordance with an exemplary embodiment of the present invention will be described in detail with reference to the accompanying drawings.

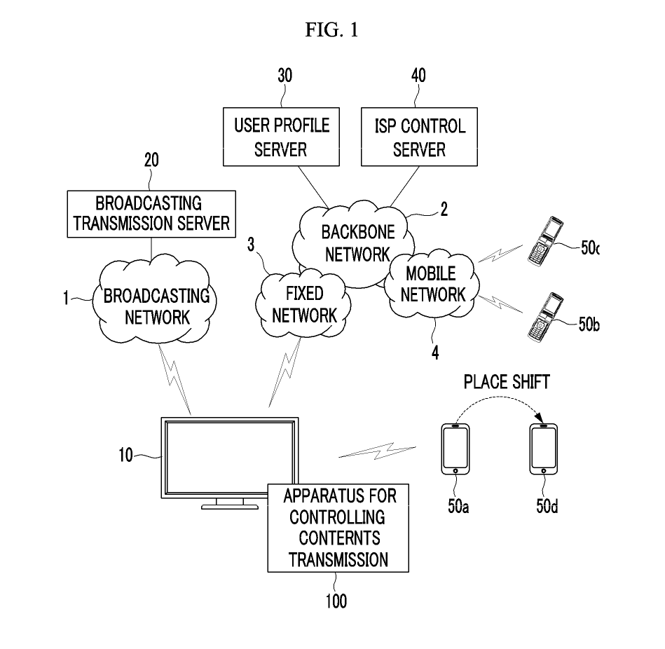

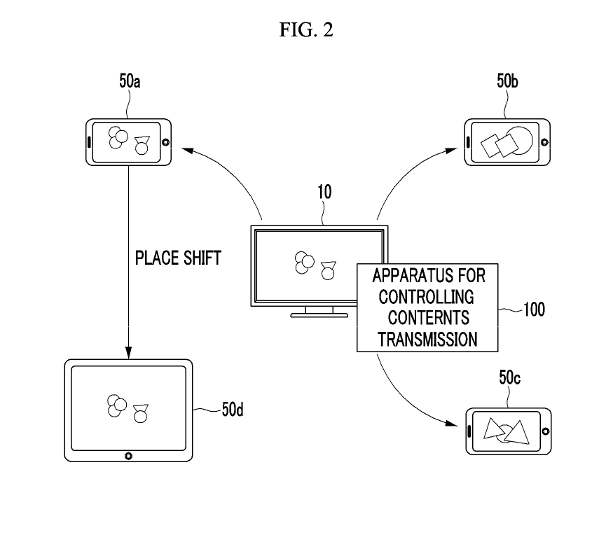

FIG. 1 illustrates network configuration where an apparatus for controlling transmission of contents in accordance with an exemplary embodiment of the present invention is applied to, and FIG. 2 illustrates a method for controlling transmission of contents, which is performed in an apparatus for controlling transmission of contents in accordance with an exemplary embodiment of the present invention.

Referring to FIG. 1, a smart TV 10 provides Internet-based contents and Internet-based service. In order to provide such contents and services, the smart TV 10 employs an operation system (OS) like a personal computer (PC) or a smart phone and is connected to the Internet. The smart TV 10 receives broadcasting contents from a broadcasting transmission server 20 through a broadcasting network 1 and provides the received broadcasting contents through a TV screen. The smart TV 10 also receives contents through streaming by accessing the Internet and provides the streaming contents through a TV screen.

The broadcasting transmission server 20 is an apparatus for transmitting broadcasting contents to the smart TV 10 through the broadcasting network 1. The broadcasting network 1 may include a terrestrial network, a satellite network, a cable network, and an Internet Protocol Television (IPTV) network. In the specification, the contents include image, voice, and data which are received through the Internet as well as broadcasting contents received through the broadcasting network 1.

The smart TV 10 may include an apparatus 100 for controlling contents transmission in order to transmit contents provided through a TV screen to at least one user terminal 50a to 50c. Users of at least one user terminal 50a-50c may be the same or different.

The apparatus 100 for controlling contents transmission may be a stand-along device that is independent from the smart TV 10.

The apparatus 100 for controlling contents transmission may provide contents provided to the smart TV 10 to at least one user terminal 50a to 50d through place-shift.

In more detail, the apparatus 100 requests user profile information of the user terminals 50a to 50c to a user profile server 30 and receives the user profile information. The apparatus 100 also guarantees quality of service (QoS) of corresponding contents by requesting guarantee of QoS to an Internet service provider (ISP) control server 40. The user profile server 30 manages user profile information and the ISP control server 40 reserves resources for guaranteeing QoS of corresponding contents. The user profile information may include information on specification, QoS, and user preference of a corresponding user terminal.

The apparatus 100 may simultaneously transmit contents of a service that a user wants to at least one user terminals 50a-50c. For example, the same contents may be transmitted to the user terminals 50a-50c. Different contents may be transmitted to the user terminals 50a-50c.

The apparatus 100 may convert contents based on the user profile information of the user terminals 50a-50c and transmit the converted contents to the user terminals 50a-50c. Furthermore, the apparatus 100 may guarantee QoS of corresponding contents in accordance with the user profile information of the user terminals 50a-50c.

When an access network of the user terminals 50a-50c is changed because the user terminals 50a-50c move, the apparatus 100 may detect a wireless interface to connect the user terminals 50a-50c and provide connection through a changed access network.

For example, when a user moves a location of a user terminal 50a to a location of another user terminal 50d in a house, the apparatus 100 may detect such user movement, tries establishing a connection to the user terminal 50d, and transmits corresponding contents to the user terminal 50d. The user terminals 50a and 50d detect coming in and out a corresponding location and transmit location information of a user to the apparatus 100 for controlling contents transmission. Accordingly, the apparatus 100 for controlling contents transmission can know the location of the user. The apparatus 100 for controlling contents transmission can detect a location of a user through other methods.

After transmitting corresponding contents to the user terminals 50a and 50d, the apparatus 100 may release a connection to the user terminal 50d if the apparatus 100 determines that contents transmission to the user terminal 50d is stable.

When a user moves to an area including a plurality of user terminals, the apparatus 100 for controlling contents transmission may select one based on a user preference that is previously registered. Unlikely, the apparatus 100 may select a user terminal closest to a user as a user terminal that the apparatus 100 transmits contents to.

The apparatus 100 may transmit different contents to each one of user terminals 50a-50c through at least one connection in accordance with characteristics of a service requested by a user.

The user terminals 50a-50d may be a multi-mode terminal that includes a plurality of network interfaces (hereinafter, “connection”) in order to access a plurality of different networks. For example, the user terminals 50a-50c may be a mobile or a portable wireless communication terminal can exchange data with another terminal or network equipment through a parent network or with the parent network through a wireless link. For example, the user terminals 50a-50d can access a General Packet Radio Services (GPRS) network, an Enhanced Data rates for GSM Evolution (EDGE), and a Universal Mobile Telecommunications System (UMTS) communication network. Furthermore, the user terminals 50a-50d may access a plurality of different wireless access networks, such as a wireless local area network, a WiFi network, and a wideband wireless communication network.

A backbone network 2 is connected to wireless access networks such as a fixed network 3 and a mobile network 4. When the backbone network 2 is an Internet protocol (IP) network, the user terminals 50a-50d is connected to an IP network through a wireless access network in order to exchange information with servers of an IP network and may access network equipments included in an external application server (or Internet sits). For example, an external application server may be a dedicated server that transmits music or video.

The user terminals 50a-50d may include an internal application that starts a service session using an external application in order to enable a user to download data managed by an external application server. For example, the user terminals 50a-50d may include a web browser.

The service session may be defined by specific characteristic and configured of different types of transactions related to service semantics. The service semantics may define a predetermined transaction given in a related application. For example, transaction may include searching for an Internet site or a page of an Internet site, request for film transmission, or request for temporally stopping or permanently stopping film.

Each transaction from internal or external requesting application includes a process of transmitting related data to a requested application appointed by a requesting application through a transmission level connection established between equipments such as a multi-mode terminal and an application server.

It is not required that the same type or different type of continuous transactions use the same high speed bit rate connection. For example, although it is not necessary to use the high speed bit rate connection to transmit a request for temporally or permanently stopping transmission of video data, transmission of video data may require a connection of a high speed bit rate. Accordingly, the apparatus 100 may transmit contents differently by each connection of the user terminals 50a to 50d in accordance with a characteristic of a service that a user wants.

Likely, the apparatus 100 may wait for a moment until a high speed bit rate is available rather than immediately starting a service session using a low bit rate connection that may cause low quality playback. For example, when a UMTS/WiFi bi-mode terminal enters into a location including WiFi hot spots, the apparatus 100 may wait for a moment in order to transmit video data with a high bit rate through a WiFi access network.

As described above, the apparatus 100 in accordance with an exemplary embodiment of the present invention transmits contents corresponding to a service according to the characteristic of the service and user profile information of each user terminal 50a to 50c in response to service requests from a plurality of user terminals 50a to 50c. For example, when a user 1 wants contents of a channel provided from the smart TV 10 through the user terminal 50a, the apparatus 100 converts contents of the channel provided from the smart TV 10 based on the user profile information of the user terminal 50a. When the user 1 moves to a location of the user terminal 50d, the apparatus 100 establishes a connection to the user terminal 50d and transmit corresponding contents to the user terminal 50d in order to seamlessly provide the corresponding contents to the user 1.

Furthermore, when a second user 2 and a third user 3 request a channel service different from that provided from the smart TV 10, the apparatus 100 processes a service request of the user terminals 50b and 50c of the second and third users 2 and 3 and transmits contents of the requested channel service to the user terminals 50b and 50c through at least one connection.

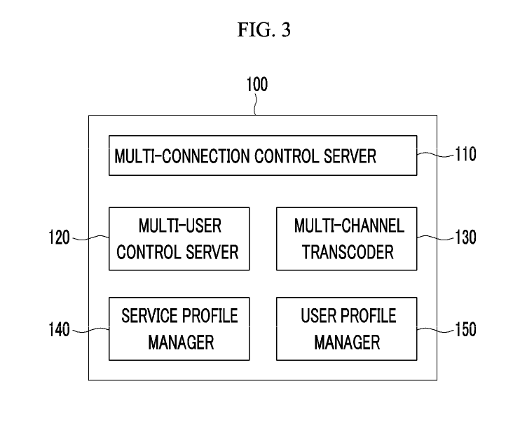

FIG. 3 illustrates an apparatus for controlling contents transmission of FIG. 1.

Referring to FIG. 3, the apparatus 100 for controlling contents transmission may include a multi-connection control server 110, a multi-user control server 120, a multi-channel transcoder 130, a service profile manager 140, and a user profile manager 150.

The multi-connection control server 110 confirms user profile information of a user terminal requesting a service, particularly, connection information and connection status, selects at least one connection to transmit contents based on the connection information and the connection status, and decides a codec scheme suitable for the selected connection. The multi-connection control server 110 transmits contents coded by the multi-channel transcoder 130 through a corresponding connection based on the characteristic profile information of a service.

Furthermore, the multi-connection control server 110 detects change of an access network of a user terminal, establishes a connection to the changed access network, and transmits contents through the corresponding connection. When user movement is detected, the multi-connection control server 110 transmits contents through at least one connection of another user terminal located at where the user moves to.

The multi-user control server 120 receives a service request from each user terminal and independently controls channels by each terminal.

The multi-channel transcoder 130 encodes contents based on a codec scheme suitable for each connection and transfers the encoded contents to the multi-connection control server 110.

The service profile manager 140 stores and manages service characteristic profile information that represents characteristics of a service.

The user profile manager 160 requests user profile information of a corresponding user terminal to the user profile server 30, receives the corresponding user profile information from the user profile server 30, and manages the received user profile information.

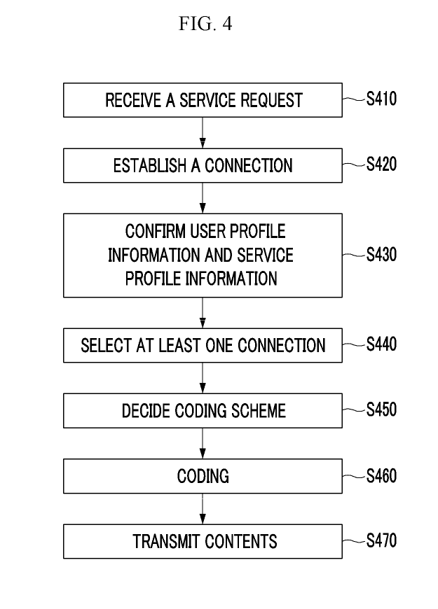

Hereinafter, a method for controlling contents transmission, which is performed by an apparatus 100 for controlling contents transmission in accordance with an exemplary embodiment of the present invention will be described with reference to FIG. 4 to FIG. 6.

For convenience, it is assumed that an apparatus 100 for controlling contents transmission is realized in a smart TV 10 in FIG. 4 to FIG. 6.

FIG. 4 illustrates a method for controlling contents transmission in accordance with the first exemplary embodiment of the present invention.

Referring to FIG. 4, a user terminal 50a requests a service to the apparatus 100 of the smart TV 10. The apparatus 100 receives a service request from a user terminal 50a at step S410 and establishes a connection to the user terminal 50a at step S420.

After establishing a connection between the apparatus 100 and the user terminal 50a, the apparatus 100 confirms the user profile information of the user terminal 50a and service profile information on a service requested by the user terminal 50a at step S430.

The apparatus 100 selects at least one connection of the user terminal 50a using the user profile information of the user terminal 50a to transmit contents at step S440 and decides a codec scheme suitable to the selected connection at step S450.

The apparatus 100 encodes the contents based on the decided codec scheme at step S460. The apparatus 100 separates and transmits the coded contents through the connection selected based on the service profile information of the service requested by the user terminal 50a at step S470.

The apparatus 100 can guarantee QoS of a corresponding connection according to the user profile information.

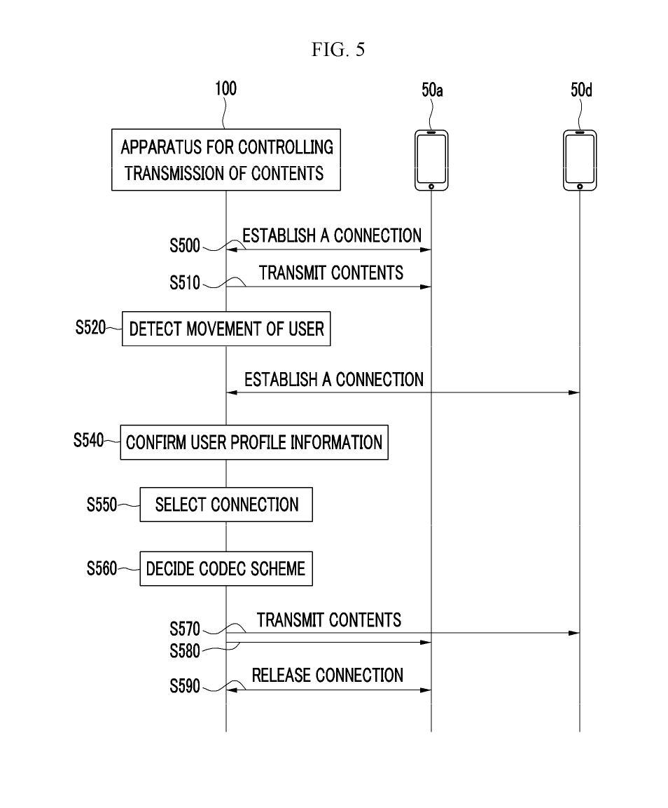

FIG. 5 illustrates a method for controlling contents transmission in accordance with the second exemplary embodiment of the present invention.

Referring to FIG. 5, a connection between the apparatus 100 and the user terminal 50a is established and the apparatus 100 transmits contents to the user terminal 50a at steps S500-S510. When user movement to the user terminal 50d is detected at step S520, the apparatus 100 establishes a connection to the user terminal 50d at step S520.

After establishing a connection between the apparatus 100 and the user terminal 50d, the apparatus 100 confirms user profile information of the user terminal 50d at step S540.

The apparatus 100 selects at least one connection of the user terminal 50d using the user profile information of the user terminal 50d at step S550 and decides a codec scheme suitable for the selected connection at step S560.

The apparatus 100 codes the contents based on the decided codec scheme and transmits the coded contents through the connection of the user terminal 50d selected based on the service profile information at step S570. The apparatus 100 may transmit contents to the user terminal 50a at step S580. When the apparatus 100 determines that the contents transmission to the user terminal 50d is stable, the apparatus 100 releases the connection to the user terminal 50a and stops transmission of contents at step S590.

When an access network of the user terminal 50d is changed because the user terminal 50d moves, the apparatus 100 detects a wireless interface that can connect the user terminal 50d and establishes a connection to the changed access network to seamlessly transmit contents to the user terminal 50d.

As described above, a user can receive contents seamlessly although the user moves without having the user terminal. Furthermore, the user can seamlessly receive contents when the access network of the user terminal is changed because the user moves with having the user terminal in a house.

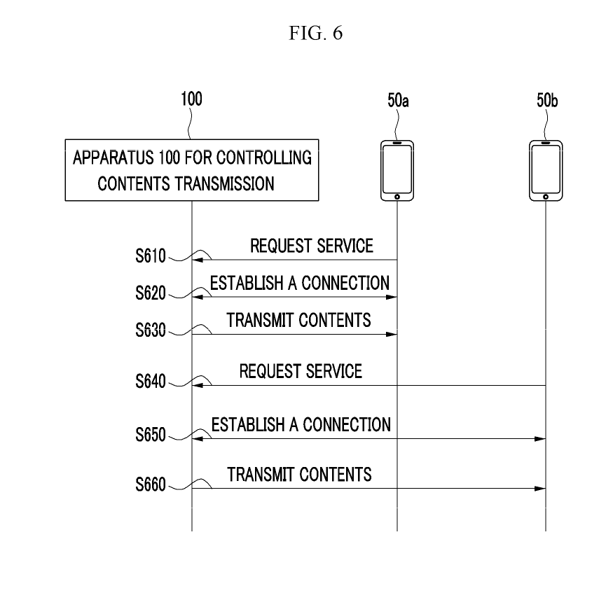

FIG. 6 illustrates a method for controlling contents transmission in accordance with the third exemplary embodiment of the present invention.

FIG. 6 shows a method for transmitting contents to a plurality of different user terminals.

Referring to FIG. 6, the apparatus 100 receives a service request from the user terminal 50a at step S610. The apparatus 100, as described in FIG. 4, establishes a connection to the user terminal 50a and transmits contents through at least one connection of the user terminal 50a using the user profile information of the user terminal 50a and the service profile information requested by the user terminal 50a at steps S620 and 630.

The apparatus 100 may receive a service request from another user terminal 50b while transmitting contents to the user terminal 50a through the connection established between the apparatus 100 and the user terminal 50a.

The apparatus 100 receives a service request from the user terminal 50b at step S640 and establishes a connection to the user terminal 50b at step S650.

After establishing a connection between the apparatus 100 and the user terminal 50b, the apparatus 100 confirms user profile information of the user terminal 50b and service profile information of a service requested by the user terminal 50b, selects at least one connection of the user terminal 50b to transmit contents, codes contents based on the codec scheme suitable for the selected connection, and transmits the coded contents through the connection selected based on the service profile information of the service requested by the user terminal 50b at step S660.

As described above, the apparatus 100 can provide contents of a corresponding service to the user terminals 50a and 50b although the user terminals 50a and 50b request a service of different channels.

In accordance with an exemplary embodiment of the present invention, an apparatus for controlling transmission of contents converts contents, which are received at a TV in a house, to be suitable to characteristic of each terminal and transmit the converted contents to another terminal while maintaining the same QoS. Accordingly, a plurality of users can watch contents, which are used to be watched through a TV in a house, at a remote place with the same quality guaranteed.

In accordance with an exemplary embodiment of the present invention, the apparatus for controlling transmission of contents supports users to simultaneously transmit contents of different channels. In case of multi-screen, an advanced service can be provided compared to a relate art providing a service for only one channel. Furthermore, the apparatus for controlling transmission of contents supports seamless transmission of contents although an access network is changed due to movement of a terminal. The apparatus also seamlessly transmit contents to another terminal by detecting movement of a user although a user moves in a house without having a terminal.

The apparatus and method according to an exemplary embodiment of the present invention described above can be realized as a program performing functions corresponding to configuration elements of the apparatus and method or as a computer readable recording medium storing the program. Since the realization can be easily implemented by those skilled in the art to which the exemplary embodiment of the present invention pertains, further description will not be provided herein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling transmission of contents received at a TV, which is performed by an apparatus for controlling transmission of contents, the method comprising:
receiving a service request from at least one user terminal;
establishing a connection to the at least one user terminal;
confirming user profile information of each user terminal and service characteristic information of services requested by each user terminal; and
transmitting contents of a corresponding service through at least one connection of each user terminal using the user profile information of each user terminal and the service characteristic information.

2. The method of claim 1, wherein the transmitting contents includes:
selecting the at least one connection of each user terminal using the user profile information of each user terminal.

3. The method of claim 2, wherein the transmitting contents further includes:
deciding a coding scheme suitable to the at least one connection; and
coding the contents based on the coding scheme.

4. The method of claim 2, wherein the transmitting contents further includes:
separating and transmitting the contents of a corresponding service through at least one connection of each user terminal according to service characteristic information of each user terminal.

5. The method of claim 1, wherein the service profile information includes QoS information, and
the transmitting contents includes requesting guarantee of QoS of contents according to the QoS information.

6. The method of claim 1, further comprising:
detecting change of an access network of each user terminal due to movement of each user terminal; and
establishing a connection to the changed access network of each user terminal.

7. The method of claim 1, wherein the apparatus for controlling contents transmission is included in the TV.

8. A method for controlling transmission of contents received at a TV, which is performed in an apparatus for controlling contents transmission, the method comprising:
receiving a service request from a user through a first user terminal;
transmitting contents of a requested service through at least one connection of the first user terminal using user profile information of the first user terminal and service characteristic information of the requested service;
detecting movement of the user; and
transmitting contents of the requested service through at least one connection of a second user terminal using user profile information of the second user terminal at a location where the user moves to.

9. The method of claim 8, wherein the transmitting contents of the requested service through at least one connection of a second user terminal includes:
transmitting contents of the requested service through at least one connection of the first user terminal.

10. The method of claim 9, wherein the transmitting contents of the requested service through at least one connection of a second user terminal further includes:
Interrupting transmission of the contents to the first user terminal.

11. An apparatus for controlling transmission of contents received at a TV, the apparatus comprising:
a multi-user control server for independently controlling a channel by a user terminal that requests a service; and
a multi-connection control server for confirming connection information and a connection state of each terminal requesting the service, selecting at least one connection of each user terminal to transmit contents corresponding to the service based on the connection information and the connection state, and transmitting the contents through the at least one connection of each user terminal.

12. The apparatus of claim 11, further comprising:
a multi-channel transcoder for coding the contents based on a coding scheme suitable to the at least one connection of each user terminal.

13. The apparatus of claim 12, wherein the multi-connection control server decides the coding scheme suitable to the at least one connection of each user terminal.

14. The apparatus of claim 11, wherein the multi-connection control server detects change of an access network of each user terminal and establishes a connection to the changed access network.

15. The apparatus of claim 11, wherein the multi-connection control server transmits the contents through at least one connection of another user terminal located at a location where a user moves to when movement of the user is detected.
